(19) United States
(12) Patent Application Publication
(10) Pub. No.: US 2015/0198160 A1
(43) Pub. Date: Jul. 16, 2015

(54) METHOD FOR OPTIMIZING THE CONTROL OF AN ELECTRIC DRIVE

(71) Applicant: Halla Visteon Climate Control Corp., Daejeon (KR)

(72) Inventors: Herr Uwe Poschenrieder, Bornheim (DE); Herr Mario Lenz, Kerpen (DE)

(21) Appl. No.: 14/593,589

(22) Filed: Jan. 9, 2015

(30) Foreign Application Priority Data
Jan. 10, 2014 (DE) 102014100214.8

(51) Int. Cl. F04C 23/02; F04C 18/02; H02P 6/10

(52) U.S. Cl. CPC F04C 23/02; H02P 6/10; F04C 18/0207

(57) ABSTRACT

A method for optimizing the regulation of an electric drive for machinery with specific torque behavior which periodically fluctuates significantly between extreme values specific to working points includes the step of implementing a characteristic field. A drive motor is provided for the electric drive with a permanent magnet rotor and a stator with a stator winding. The stator winding is energized with a three-phase alternating current across an inverter. Changes in the number of revolutions of the drive motor and the angle error are minimized by a correction of this phase current and a correction of the angular velocity. The characteristic field for the torque variation which is specific to the machine is implemented in the regulation algorithm of the inverter.

### CROSS-REFERENCE TO RELATED APPLICATIONS

This application claims priority to German Patent Application No. 10-2014-100214.8, filed on Jan. 10, 2014, the disclosure of which is incorporated herein by reference in its entirety.

### FIELD OF THE INVENTION

The invention concerns a method for optimization of the regulation of an electric drive for machinery with specific torque variation. In particular, the invention concerns a method for regulating an electric drive for air conditioning compressors.

### BACKGROUND OF THE INVENTION

The invention is generally intended for machinery with specific torque variation, which fluctuates significantly between extreme values specific to working points in periodic fashion, i.e., within a work stroke or a revolution of the drive shaft, for example. This holds, for example, for air conditioning compressors which work by a scroll compressor technique. A typical torque variation results from a compression process produced with the compressor. This torque variation for the compression process in the scroll compressor is predominantly dictated by the compressor geometry, which is chosen by design and cannot be varied during operation, and by the compressor suction pressure Ps and the compressor end pressure Pd which are present at a specific operating point.

In an electrically driven compressor, a phase current is delivered to an electric motor, such as a permanent magnet motor, which brings about the compression process. The motor is actuated by an inverter, which supplies a three-phase alternating current to a stator winding and drives a rotor of the motor, outfitted with permanent magnets, by the resulting rotary field.

In order to properly actuate the drive motor, the inverter must recognize the position of the rotor relative to coils of the stator. Thus, familiar regulation strategies are implemented in an arithmetic unit of the inverter. A speed regulation is done by evaluating measured electrical values, from which the reactive current component is calculated. The reactive current component constitutes a measure of an angle error between the rotor and the circulating rotary electric field. An instantaneous position of the rotor relative to the rotary field is continually adjusted by a corresponding correction of the phase current and a concomitant torque change, as well as a correction of the angular velocity of the rotary field and a concomitant compensation of the angle error, so that keep reactive current component does not pass a given limit value. In this way, the rotary field and the rotor should be maintained in the same phase.

Every operating load produced during the compression process automatically leads to a change in the angle error or phase error, which needs to be compensated by a regulation algorithm of the inverter. This holds for both constant operating loads and for dynamic operating load changes which have to be handled by the control software which is implemented. Depending on the static and the dynamic range of the ability to compensate for operating loads, a sophisticated processing unit needs to be implemented in order to make possible the necessary regulating capability, for example, holding the rotational speed of the drive motor constant. In particular, operating loads or torques oscillating periodically with a fundamental frequency result either in wrong orientation of the rotor/stator flow, which causes power losses, or they needlessly increase the required computing performance, resulting in higher costs and lower efficiency.

Thus, for the proper operation of the permanent magnet motor, the essential task of the inverter regulation is to carefully track the rotor position of the motor and correct it to the desired angle in relation to the magnetic flux in the stator. The continual evaluation of the measurement signal and the calculation of the correction values require a sophisticated signal processor, which computes the required modulation of the rotary field by way of the programmed regulation algorithms of the inverter.

### SUMMARY OF THE INVENTION

The problem being solved by the invention consists in providing a method for regulation of an electric drive for machinery with specific torque variation, especially for a compressor of an air conditioning system, in which the required computing power of the drive motor regulation in the inverter can be lowered—as compared to methods known thus far—and the regulation can be optimized.

The problem of the invention is solved by a method according to claim 1. This is a method for optimization of the regulation of an electric drive for machinery with specific torque variation, which fluctuates periodically and significantly between extreme values specific to working points, wherein a drive motor with a permanent magnet rotor and a stator with a stator winding is provided for the electric drive, and the stator winding is supplied with a three-phase alternating current across an inverter and the changes in the rotary speed of the drive motor and the angle error are minimized by a correction of this phase current and a correction of the angular velocity. According to the invention, a characteristic field specific to the machine is implemented for the torque variation in the regulation algorithm of the inverter, the implementation of the characteristic field involving the following steps:
I Creation of a model for the operating load variation, with which the torque variation can be calculated,
II Creation of a torque variation matrix, consisting of a plurality of torque curves specific to the working points and resulting from the compression process over the entire operating range of the machine driven by the electric motor,
III Calculation of mechanical variables from the operating load by means of the torque variation matrix so created,
IV Derivation of the characteristic field and
V Implementation of this characteristic field in the regulation algorithm of the inverter.

On the basis of torque curves determined from the characteristic field for the particular working points and the other variables, correction values are computed and processed for the phase current and for the angular velocity of the rotary field.

In the methods known thus far, the regulating parameters and the modulated phase current output are derived by evaluation of real time detected electrical measurement values, such as information about the reactive power component, which the control software of the inverter receives in the form of feedback. According to the concept of the invention, now, a predictive function is provided with the characteristic field for the static and dynamic operating behavior of the machine and this is implemented in the regulation algorithm, this predictive function being dependent on the actual operating states of the machine. This is done by integration of the characteristic field in the regulation algorithm, with the characteristic field mapping the periodic torque curves specific to the working points. In this way, the required computing power for calculating the control variable to keep the speed constant or to monitor the speed and to minimize the changes in angular velocity or rotary speed of the drive shaft can be minimized Thanks to the reduced computing expense, a processor of a lower power class is sufficient in an ideal case.

If the machine is a compressor of an air conditioning unit, in order to accomplish a high-performance motor regulation with low computing power, one makes use of a specific operating load characteristic curve that is determined for the compressor. This is implemented by means of the characteristic field, which is determined carefully by investigating the air conditioner system pressures and compressor speed. The operating load correction values so derived are relayed to a regulatory circuit of the drive motor to compensate for perturbations. That is, the dynamic, predicted perturbation information in the form of the characteristic field is implemented in the regulation algorithm of the inverter, in order to predict and modulate the required correction value of the phase current as a control variable based on the characteristic operating load curves of the driven compressor and thus ensure a continual rotor timing. The method of the invention is preferably suitable for a compressor as the machine, configured as a scroll compressor with torque curve dependent on the compressor suction pressure.

In step III of the method, the instantaneous angular acceleration is preferably calculated as the mechanical variable from the operating load by means of the torque variation matrix that was created. According to an especially advantageous embodiment of the invention, in an additional step IIIa, following step III of the method, another quantity characteristic of the torque variation matrix that is able to be used to calculate the control variable is calculated in order to reduce the complexity of the characteristic field. One such quantity characteristic of the torque variation matrix and able to be used to reduce the complexity of the characteristic field in step IIIa of the method is a maximum phase error φMAX between the rotor and the electric field rotating in the stator, which is caused by periodic load changes at a working point of the machine.

### BRIEF DESCRIPTION OF THE DRAWINGS

Further details, features and benefits of the invention will emerge from the following description of sample embodiments making reference to the corresponding drawings. There is shown:

FIG. 1: a cross section of a compressor as a machine according to an embodiment of the disclosure;

FIG. 2: steps I-III of a method to create and implement a characteristic field for a torque variation of a drive motor in the regulation algorithm of an inverter according to an embodiment of the disclosure;

FIG. 3: steps IIIa-IV of the method to create and implement the characteristic field of FIG. 2; and

FIG. 4: step V of the method to create and implement the characteristic field of FIGS. 1-2.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. Throughout the drawings, components identical with those of the conventional air conditioning system controller described earlier will be designated by like reference symbols.

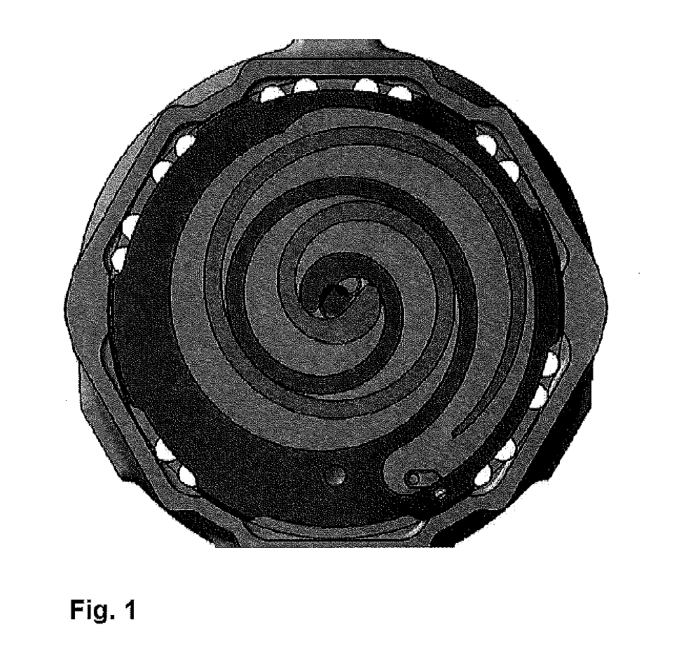

FIG. 1 shows a cross section of a compressor of an air conditioning unit, working by a scroll compressor principle. This serves as a sample embodiment of a machine with specific torque variation, which fluctuates significantly between extreme values specific to working points periodically within a work stroke or a revolution of the drive shaft, respectively.

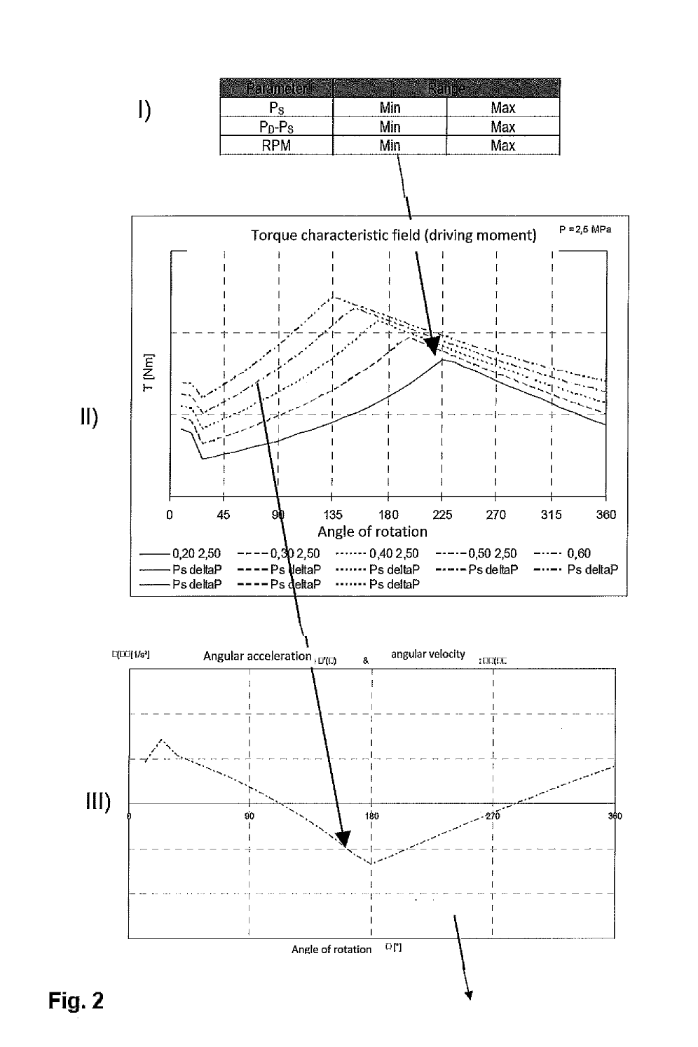

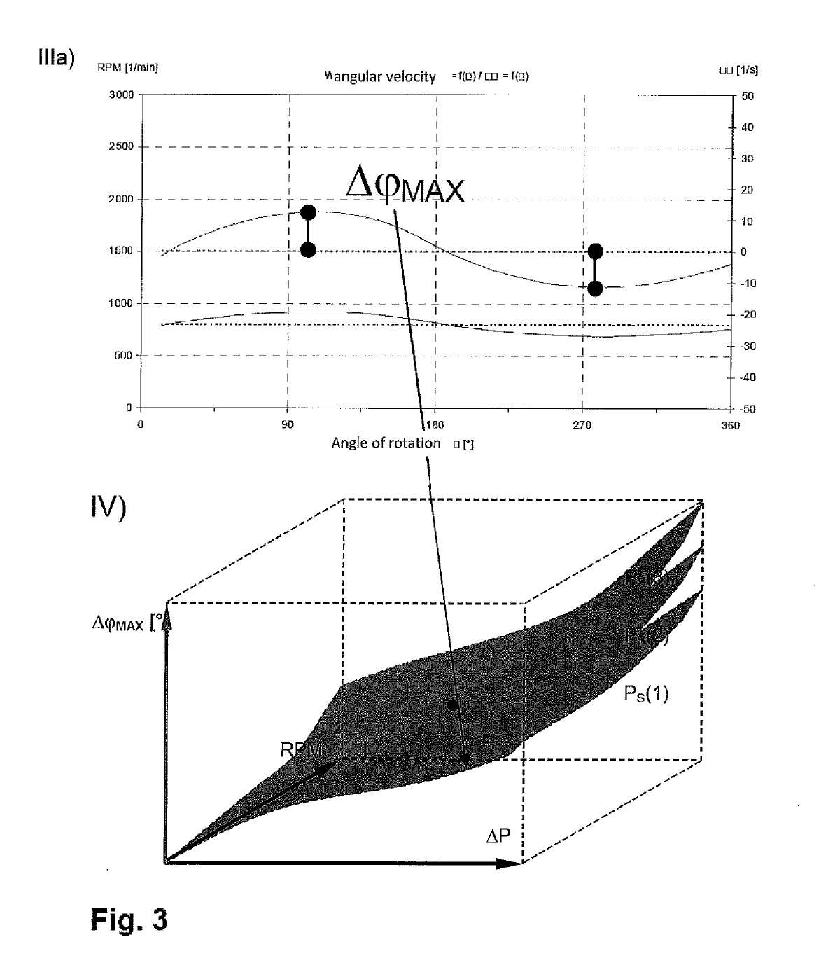

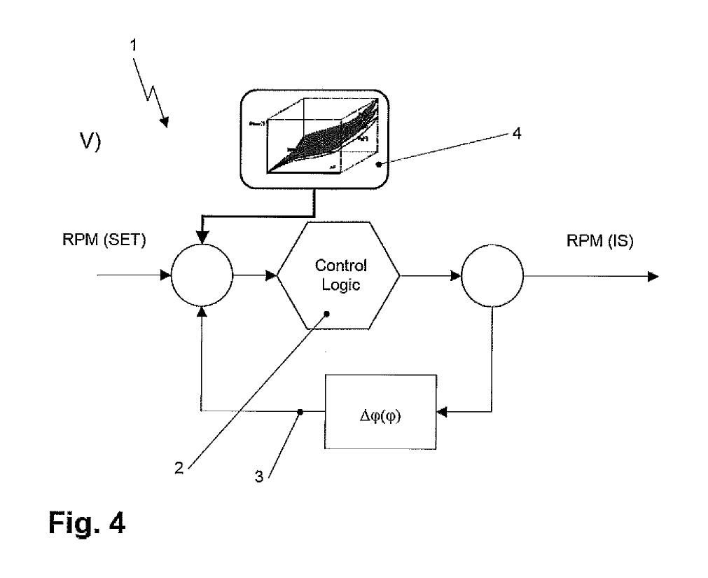

The preparation and implementation of a characteristic field for the torque variation of an electric drive for the compressor requires the following steps:
I. First of all, a model is created for the operating load variation, with which a driving moment T or a torque T can be calculated. FIG. 2 shows, under I in table form, a working point matrix with the parameters of a compressor suction pressure Pₛ, a difference ΔP between a compression end pressure P_{d} and compressor suction pressure Pₛ, and a rotary speed RPM, which take on a particular value at each working point within the operating range between a minimum value MIN and a maximum value MAX. The compression end pressure P_{d} is the system high pressure in the cooling circuit or heat pump circuit hooked up to the compressor. The compressor suction pressure Pₛ is the system low pressure in the range between coolant expansion element, evaporator unit, and compressor inlet.
II. Next, at all working points of the working point matrix, that is, the entire operating range of the compressor, one determines the torque variation calculated with the theoretical model for the compression process as a function of an angle of rotation φ. The compression process by the compressor results in a typical torque variation, dependent on the compressor suction pressure Pₛ and the compression end pressure P_{d}, which is shown in FIG. 2 under II in the form of a diagram. The torque T is given in units of [Nm] and the compressor suction pressure Pₛ in units of [MPa]. The torque T is plotted here as a function of the angle of rotation φ, indicated in [°]. In this way, one composes a torque variation matrix over the entire operating range of the compressor driven by the electric motor, as shown in step II in FIG. 2.
III. In this step, further mechanical variables can be computed from the operating load. As shown under step III in FIG. 2, the variable calculated is an instantaneous angular acceleration α as a function of the angle of rotation φ, where α(φ) is indicated in [1/s²].
III. As shown by FIG. 3, in order to reduce the complexity of the characteristic field, in a further step IIIa, there is the option of calculating a quantity which is characteristic of the torque variation matrix and which can likewise be used to calculate the variable. As shown specifically in FIG. 3, this can be a determined or calculated maximum angle or phase error ΔφMAX, caused by periodic load changes at a working point of the machine. An angle error Δφ of the compressor stage is referred to the nominal rotary speed and arises due to the actual periodic torque demand of the compression process. The phase error of the supplied rotary current Δν, fixed for the angular velocity, results directly from the instantaneous position angle error of the mechanism of the compressor stage. By the introduction of an active correction of the angular velocity, a tolerance Δν results for the maximum permitted phase error ΔφMAX.
IV. Finally, one derives a characteristic field, as is shown under IV in FIG. 3. Specifically, FIG. 3 shows, as the characteristic field, a regression curve arrangement for the maximum phase error ΔφMAX.
V. This characteristic field is then implemented in control software 2 of the inverter and thus in its regulating circuit or a regulating algorithm 1, as can be seen in FIG. 4.

A corresponding regulating algorithm 1 of an inverter for the regulation of the compressor speed RPM of the air conditioning unit is shown schematically in FIG. 4. Unlike with the prior art, the regulating parameters and the modulated phase current output are not derived by evaluation of real time detected electrical measurement values which the control software 2 of the inverter can receive in the form of a feedback 3. Only the compressor speed setting RPM (Soll) and other parameters, such as the compressor suction pressure Pₛ and the compression end pressure or network pressure P_{d}, which define the particular working point, are entered into the control software 2 of the inverter. In addition, the above-described characteristic field 4 is provided as a predictive function for the static and dynamic operating load behavior of the machine, dependent on the actual operating states of the machine, and implemented in the control software 2 of the inverter and thus in its regulating algorithm 1. The characteristic field 4 contains information on the maximum phase error ΔφMAX, which has a definite value at every working point with the parameters RPM; Pₛ; Pₛ−P_{d}=ΔP; and which is characteristic of a particular torque variation or periodic phase error variation Δφ(φ) at the respective working point. On the basis of the phase error variation Δφ(φ) so derived, a corresponding correction can be made in the phase current and a correction in the angular velocity of the rotary field. With the implementation of the characteristic field 4, the required computing power can be minimized for holding constant the actual compressor speed RPM (IST) and for minimizing the angular velocity changes during a work stroke.

While certain preferred embodiments of the invention have been described above, the present invention is not limited to these embodiments. It is to be understood that various changes and modifications may be made without departing from the scope of the invention defined in the claims.

### LIST OF REFERENCE NUMBERS

1 Regulation circuit, regulation algorithm
2 Control software
3 Feedback
4 Characteristic field
RPM Speed, compressor speed
RPM (SOLL) Compressor speed setting
RPM (IST) (Actual) compressor speed
ΔφMAX Maximum phase error, maximum angle error
T Driving moment, torque
Pd Compression end pressure, system high pressure in the cooling circuit or heat pump circuit connected to the compressor
Ps Compressor suction pressure, system low pressure in the region between coolant expansion element, evaporator unit and compressor inlet
ΔP Difference between Pd and Ps
φ Angle of rotation
α Instantaneous angular acceleration
Δφ Angle error

ΔφMAX Maximum angle or phase error
ΔφMAX (φ) Periodic phase error variation
Δφ(φ) Torque variation or periodic phase error variation

What is claimed is:

1. A method for optimizing a regulation of an electric drive comprising the steps of:
providing a drive motor for a machine with a specific torque variation, the drive motor having a permanent magnet rotor and a stator having a stator winding;
energizing the stator winding with a three-phase alternating current output by an inverter to actuate the drive motor, the inverter including a regulation algorithm configured to minimize a change in a number of revolutions of the drive motor and an angle error of the drive motor;
implementing a characteristic field of the machine in the regulation algorithm, the implementing of the characteristic field comprising the steps of:
creating a model of a variation of an operating load of the machine in the regulation algorithm to calculate a torque variation of the drive motor;
creating a torque variation matrix with the model of the variation of the operating load in the regulation algorithm, the torque variation matrix including a plurality of torque curves of the drive motor resulting from an operating range of the machine driven by the electric motor;
calculating at least one mechanical variable from the torque variation matrix with the regulation algorithm;
deriving the characteristic field from the at least one mechanical variable from the torque variation matrix with the regulation algorithm; and
implementing the characteristic field in the regulation algorithm; and
processing a correction value for a phase current and an angular velocity of a rotary field of the drive motor, the correction value calculated from the characteristic field implemented in the regulation algorithm and applying the correction value to the regulation algorithm to change the three-phase alternating current output from the inverter.

2. The method according to claim 1, wherein the machine is a scroll compressor, and wherein the plurality of torque curves is dependent on a suction pressure of the scroll compressor.

3. The method of claim 2, wherein the model of the variation of the operating load includes a torque of the drive motor parameter, a compressor suction pressure parameter, a compression end pressure parameter, and a difference between the compression end pressure and the compressor suction pressure parameter.

4. The method according to claim 1, wherein the at least one mechanical variable is an instantaneous angular acceleration of the drive motor.

5. The method of claim 1, further comprising the step of calculating a quantity from the torque variation matrix to compute a control variable, the calculating of the quantity from the torque variation matrix configured to minimize a complexity of the characteristic field.

6. The method of claim 5, wherein the quantity from the torque variation matrix is a maximum phase error between the rotor and the rotary field of the drive motor.

7. The method of claim 1, wherein the characteristic field is implemented in a control software of the inverter.
